(19) United States
(12) Patent Application Publication
(10) Pub. No.: US 2007/0124343 A1
(43) Pub. Date: May 31, 2007

(54) Method or apparatus for processing data in a system management application program

(75) Inventors: Madan Ganesh Velayudham, Bangalore (IN); Rudyard Merriam, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 11/289,554

(22) Filed: Nov. 30, 2005

(51) Int. Cl. G06F 17/30

(52) U.S. Cl. 707/203

(57) ABSTRACT

A method or apparatus is disclosed for processing data in a system management application program in which change data from the system being managed is pre-processed in order to reduce unnecessary processing by the system management application program.

### FIELD OF INVENTION

A method or apparatus for processing data in a system management application program.

### BACKGROUND OF THE INVENTION

Computer systems, such as data centres, can be managed automatically by system management application programs. Such application programs carry out a number of tasks including modifying the computer system in response to system faults or user input. System faults can be detected by an automatic monitoring system. A user interface (UI) accepts inputs which may include requests to add or remove devices, such as servers, switches or storage, from the system. The UI also enables the user to modify or change software in the system or to instruct processing of data in the system. The monitoring and user input data is held in a queue until it is processed by a decision making component such as a policy engine. The policy engine uses a set of rules or policies to convert the user inputs or monitoring data into appropriate commands for a provisioning system. The provisioning system then modifies the computer system being managed in response to the commands. The provisioning system may also provide feedback data on the progress, success or failure of its provisioning actions to the policy engine via the queue.

One problem with this arrangement is that in a system where frequent changes are made or large amounts of feedback are produced, the processing of the feedback or user inputs into commands for the provisioning system becomes slow or requires a large amount of processing resource.

### SUMMARY OF THE INVENTION

An embodiment provides a method for processing data in a system management application program, the method comprising the steps of:
a) accessing a set of data elements collected for the system being managed by the system management application, each data element comprising a message defining a change in the computer system and an associated time stamp;
b) identifying groups of data elements in the set which correspond to contradictory or duplicated messages for the system management application program;
c) converting the data element messages into commands for sequential processing in accordance with the time stamps by the system management application program; and
d) for any groups of data elements that are identified as contradictory or duplicated, converting only the most recent data element, according to the time stamps, for processing in the sequential processing.

If a group of data elements are identified as duplicated and if the commands determined by the group of data elements can be carried out collectively then the whole group of data elements may be converted into commands for processing in the sequential processing. If a group of data elements are identified as duplicated and the commands determined by the group of data elements can not be carried out collectively then only the most recent data element, according to the time stamps, may be converted for processing in the sequential processing.

A set of rules may define which commands can be carried out collectively. A set of rules may be used to identify data element messages which are contradictory or duplicated. The data elements may identify a device and a data set in the system to which the commands are directed. A subset of the set of data elements may be selected for processing, the selection being based the time stamps. The subset selection may be carried out at predetermined time intervals.

The method may be carried out by a decision making component associated with the system management application program, the component being arranged to convert the data elements into commands for the system in accordance with a set of management rules. Step c) may be carried out by a policy engine and step d) may be carried out by a data element pre-processor. Instead of the time stamp, each data element may be assigned a unique sequence number used to determine the time order of the data element relative to other data elements.

Another embodiment provides a method for processing data in a system management application program, the method comprising the steps of:
a) retrieving a set of data elements collected for the system being managed by the system management application program, each data element comprising a message defining a change in the system and a time stamp;
b) identifying one or more groups of data elements in the set which correspond to contradictory or duplicated messages for the system management application program;
c) for any groups of data elements identified as contradictory or duplicated, processing the set by removing all except the most recent identified data element from the set; and
d) storing the processed set for use by a decision making component of the system management application program.

A further embodiment provides apparatus for processing data in a system management application program, the apparatus being operable to:
access a set of data elements collected for the system being managed by the system management application program, each data element comprising a message defining a change in the system and a time stamp;
identify one or more groups of data elements in the set which correspond to contradictory or duplicated messages for the system management application program;
convert the data element messages into commands for sequential processing in accordance with the time stamps by the computer system management application program; and
for any groups of data elements that are identified as contradictory or duplicated, convert only the most recent data element, according to the time stamps, for processing in the sequential processing.

Another embodiment provides apparatus for processing data in a system management application program, the apparatus being operable to:
retrieve a set of data elements collected for the system being managed by the system management application program, each data element comprising a message defining a change in the system and a time stamp;
identify one or more groups of data elements in the set which correspond to contradictory or duplicated messages for the system management application program;
for any groups of data elements identified as contradictory or duplicated, process the set by removing all except the most recent identified data element from the set according to the time stamps; and
store the processed set for use by a decision making component of the system management application program.

A further embodiment provides apparatus for processing data in a system management application program, the apparatus comprising:
means for retrieving a set of data elements collected for the system being managed by the system management application program, each data element comprising a message defining a change in the system and a time stamp;
means for identifying one or more groups of data elements in the set which correspond to contradictory or duplicated messages for the system management application program;
means for processing the set by removing all except the most recent identified data element from the set according to the time stamps, for any groups of data elements identified as contradictory or duplicated; and
means for storing the processed set for use by a decision making component of the system management application program.

Another embodiment provides program or group of programs arranged to enable a programmable device or group of programmable devices to carry out a method for processing data in a system management application program, the method comprising the steps of:
a) accessing a set of data elements collected for the system being managed by the system management application, each data element comprising a message defining a change in the computer system and a time stamp;
b) identifying groups of data elements in the set which correspond to contradictory or duplicated messages for the system management application program;
c) converting the data element messages into commands for sequential processing in accordance with the time stamps by the system management application program; and
d) for any groups of data elements that are identified as contradictory or duplicated, converting only the most recent data element, according to the time stamps, for processing in the sequential processing.

A further embodiment provides a program or group of programs arranged to enable a programmable device or group of programmable devices to carry out a method for processing data in a system management application program, the method comprising the steps of:
a) retrieving a set of data elements collected for the system being managed by the system management application program, each data element comprising a message defining a change in the system and a time stamp;
b) identifying one or more groups of data elements in the set which correspond to contradictory or duplicated messages for the system management application program;
c) for any groups of data elements identified as contradictory or duplicated, processing the set by removing all except the most recent identified data element from the set according to the time stamps; and
d) storing the processed set for use by a decision making component of the system management application program.

Another embodiment provides program or group of programs arranged to enable a programmable device or group of programmable devices to provide apparatus for processing data in a system management application program, the apparatus being operable to:
access a set of data elements collected for the system being managed by the system management application program, each data element comprising a message defining a change in the system and a time stamp;
identify one or more groups of data elements in the set which correspond to contradictory or duplicated messages for the system management application program;
convert the data element messages into commands for sequential processing in accordance with the time stamps by the computer system management application program; and
for any groups of data elements that are identified as contradictory or duplicated, convert only the most recent data element, according to the time stamps, for processing in the sequential processing.

A further embodiment provides a program or group of programs arranged to enable a programmable device or group of programmable devices to provide apparatus for processing data in a system management application program, the apparatus being operable to:
retrieve a set of data elements collected for the system being managed by the system management application program, each data element comprising a message defining a change in the system and a time stamp;
identify one or more groups of data elements in the set which correspond to contradictory or duplicated messages for the system management application program;
for any groups of data elements identified as contradictory or duplicated, process the set by removing all except the most recent identified data element from the set according to the time stamps; and
store the processed set for use by a decision making component of the system management application program.

Another embodiment provides program or group of programs arranged to enable a programmable device or group of programmable devices to provide apparatus for processing data in a system management application program, the apparatus comprising:
means for retrieving a set of data elements collected for the system being managed by the system management application program, each data element comprising a message defining a change in the system and a time stamp;
means for identifying one or more groups of data elements in the set which correspond to contradictory or duplicated messages for the system management application program;
means for processing the set by removing all except the most recent identified data element from the set according to the time stamps, for any groups of data elements identified as contradictory or duplicated; and
means for storing the processed set for use by a decision making component of the system management application program.

### BRIEF DESCRIPTION OF THE DRAWINGS

Embodiments of the invention will now be described, by way of example only, with reference to the accompanying drawings in which:

FIG. 1 is a schematic illustration of a computer system;

FIG. 2 is a table illustrating data elements used in the computer system of FIG. 1; and

FIG. 3 is a flow chart illustrating processing carried out in the computer system of FIG. 1.

### DETAILED DESCRIPTION OF PREFERRED EMBODIMENTS OF THE INVENTION

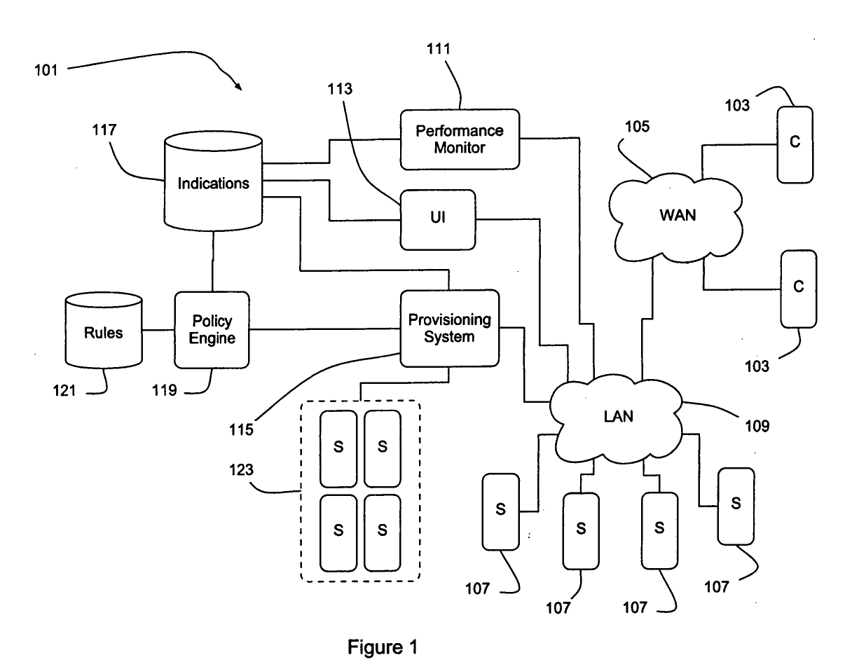

With reference to FIG. 1, a computer system 101 comprises client computers (C) 103 which are connected via a wide area network (WAN) 105 to a web service provided by a group of servers (S) 107. The servers (S) 107 are interconnected by a local area network (LAN) 109. The LAN also connects a performance monitoring application 111, a user interface application (UI) 113 and a provisioning system 115 to the servers (S) 107. The performance monitoring application 111 monitors a predetermined set of events in the servers 107 such as the failure of an operating system (OS) on a server or the addition of a server into the group. Any such events or indications are logged by the performance monitoring application 111 in an indication store 117. Similarly, the UI 113 is arranged to enable a user to make changes to the group of servers 107, such as performing a back up, adding or removing a server or creating a new data set or data collection. In response to such user inputs, the UI 113 is arranged to log the desired changes in the indication store 117.

The indication store 117 is connected to a decision making component of the computer system 101, in the form of a policy engine 119 which is also connected to the provisioning system 115. The policy engine 119 applies a set of rules 121 to the indications in the indication store 117 to produce commands for the provisioning system 115. The commands produced are designed to provide an appropriate response to each indication. The provisioning system 115 responds to received commands by making changes to the group of servers 107. The provisioning system has access to a pool of spare servers 123 for use when servers are added to, or removed from, the group of servers 107.

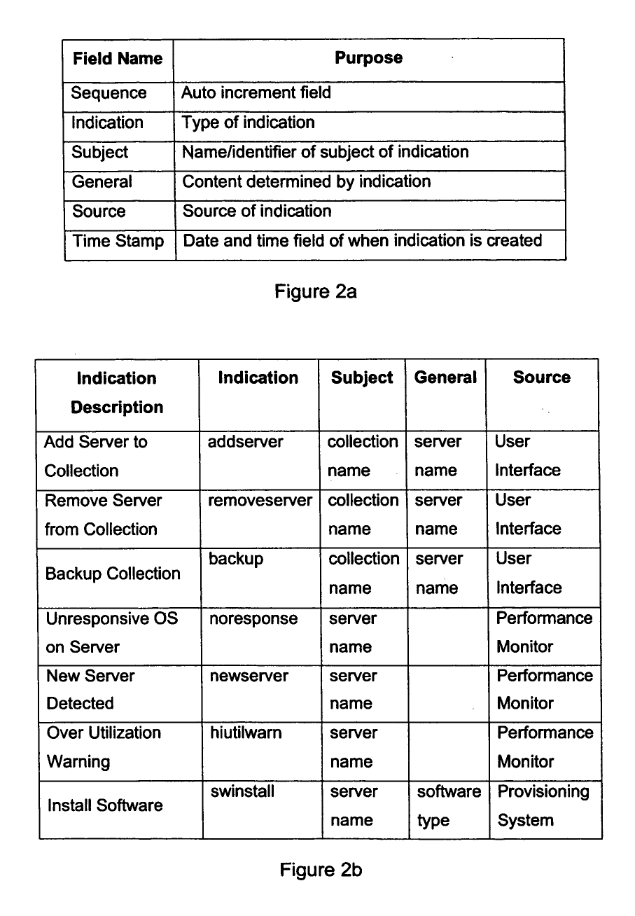

Each indication is a data element which carries details of a change which has occurred, or is requested, in the servers 107. Each indication, in the present embodiment, has six fields as shown in the table of FIG. 2a. The Sequence field is used to order and uniquely identify the indications in the indication store 117. Each time an indication is added, it is given the next sequence field value to the last added indication. The Indication field identifies the type of indication and will be described further with reference to FIG. 2b below. The Subject field holds the name of the server or data collection to which the indication relates. The subject may therefore be a target of change or an element providing fault or other data. The General field is used to carry further information for use by the policy engine 119 or the provisioning system 115. The Source field identifies the source of the indication. The Time Stamp field contains an indication of the time at which the indication was created by the source identified in the Source field.

Some examples of indications in the present embodiment are set out in FIG. 2b. The first indication is created by the UI 113 and is a request for the provisioning system to add a server to the group of servers 107. The indication defines a collection of data to be held on the server and the server name. The next indication is again from the UI 113 and is a request to remove a server from the group 107. This “remove server” indication is the reverse of the “addserver” indication when they each refer to the same server. In other words, the “addserver” and “remove” server indications are contradictory when applied to the same server. The third indication is a request to back up a given data collection on a given server in the group 107 and is again issued from the UI 113. If, for example, two “backup” indications refer to the same server but different data collection then both back up operations should be carried out.

The fourth, fifth and sixth indications in the table of FIG. 2b are status information about given servers in the group 107 and are generated by the performance monitoring application 111. The fourth indication shows that the given server has an operating system (OS) which is failing to respond and may require rebooting. The fifth indication shows that a new server has been detected either as a result of a provisioning request or that a server that had become unavailable has now resumed availability. The sixth indication shows that a given server is being over used and needs to be supplemented with another server to ease its workload.

The seventh indication in the table of FIG. 2b is a request to install given software of a given type on a named server, and is created by the provisioning system 115. If two “swinstall” indications for the same server are present then whether or not they are complimentary or destructive depends on the type of the software being installed. For example if both indications are attempting to install an OS on the same server then the indications are destructive and only one installation should succeed. If however, one or both of the indications refer to different application software then both installations may be carried out.

In the present embodiment, the policy engine 119 is arranged pre-processes indications in the indication store 117 prior to processing them in accordance with the policy rules 121. The pre-processing selects a group of indications and analyses them to identify any which are duplicated or contradictory. A set of rules, stored with the policy rules 121 defines which combinations of indications constitute duplicated or contradictory indications. Contradictory indications are paired and can be defined as two indications which reverse each others actions. In other words, if two contradictory indications were processed one after the other there would be no change in the group of servers 107. Duplicated indications fall into two further categories in that they may be either complimentary or destructive. Complimentary duplicated indications are indications which would not result in any duplication of processing and whose processing does not interfere with each other. Destructive duplicated indications are those whose processing would interfere with each other. Some examples of duplicated and contradictory indications are set out below.

### EXAMPLE 1

A Duplicated Destructive Indications Pair:

14:31, Addserver, Server1, Collection1, Window™ installation;
14:32, AddServer, Server1, Collection2, Linux™ installation.

In this example, operating systems are being installed on the same server. Clearly both should not be installed as one overrides the other. Only the later Linux™ installation should proceed as a Windows™ installation on the same server is invalid.

### EXAMPLE 2

A Duplicated Complimentary Indication Pair:

14:33, Addserver, Server1, Collection1, Backup C;
14:34, AddServer, Server1, Collection2, Backup D.

In this example, both operations can be carried out since each back up operation refers to a different data collection on the server.

### EXAMPLE 3

A Series of Contradictory Indications:

14:35, newserver, server2;
14:36, noresponse, server2;
14:37, newserver, server2.

In this example, a recovery action which might be initiated for the “noresponse” indication need not be carried out as the server in question has resumed responding.

### EXAMPLE 4

A Pair of Duplicated Indications:

14:38, newserver, server3;
14:39, newserver, server3.

In this example, the first indication is redundant.

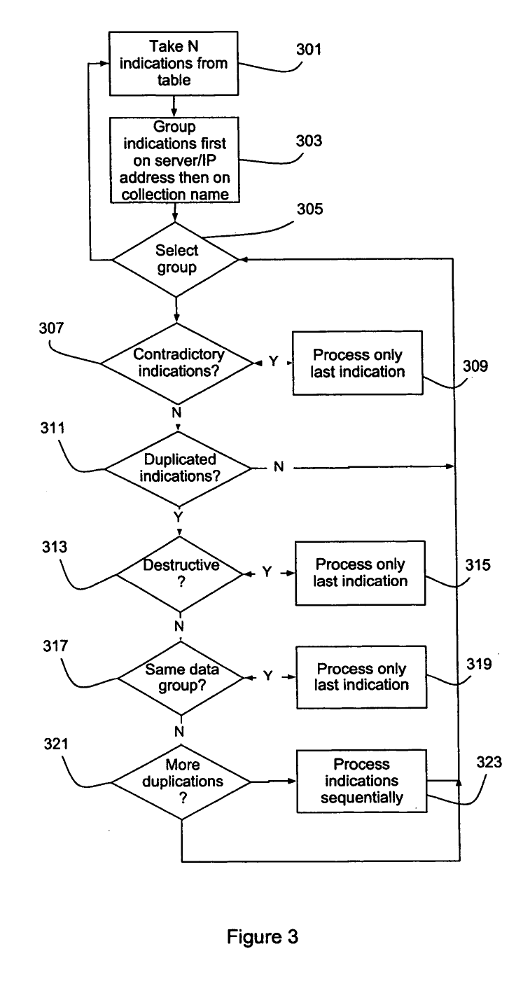

The processing carried out by the policy engine 119 when pre-processing the indications in the indication store 117 will now be described further with reference to the flow chart of FIG. 3. At step 301, a set of the 20 most recent indications, according to their time stamps, is selected from the indications store 117 and processing moves to step 303. At step 303 the indications are grouped firstly on the server name and then on data collection name in order to simplify the searching for duplicated or contradictory indications. Processing then moves to step 305 where the first group from the grouped set of indications is selected and processing moves to step 307. At step 307, a search is carried out for any contradictory statements as defined in the pre-processing rules. If any contradictory statements are identified then processing moves to step 309 where all but the most recent indication, as identified by the time stamps, is removed from the group of indications. Processing then returns to step 307 and moves on to step 311.

At step 311 the group of indications is searched for any duplicated indications. If none are identified then processing moves returns to step 305 where the next group of indications is selected and processing continues as described above. If at step 311, duplicated indications are identified then processing moves to step 313. At step 313, the duplicated indications are inspected to determine whether they are destructive as defined in the pre-processing rules, and if so, processing moves to step 315 where all but the most recent indication, as identified by the time stamps, is removed from the group of indications. Processing then returns to step 313 and moves on to step 317. Similarly, if at step 313 the duplicated indications are not identified as destructive then processing moves to step 317.

At step 317, the indications are analysed to determine if they refer to the same data collection. In other words the indications are checked to determine if they are pure repetitions of each other. If this is the case then processing moves to step 319 where all but the most recent indication, as identified by the time stamps, is removed from the group of indications. Processing then returns to step 317 and moves on to step 321. Similarly, if at step 317 the duplicated indications are not identified as repetitions then processing moves to step 321. At step 321, the indications are searched for any remaining duplications which will be both non-destructive and are not pure repetitions. If further duplicated indications are identified then processing moves to step 323 where the duplicated complimentary indications are left in the group of indications for sequential processing by the policy engine 119.

Processing then returns to step 305 where the next group is selected. If at step 321 no further duplications are identified then processing also returns to step 305 as described above. From step 305, processing continues until all the groups in the grouped set of indications selected from the indications store 117 have been processed, leaving the set pre-processed ready for further processing by the policy engine 119 to produce commands for the provisioning system 115.

In another embodiment, the policy engine is arranged to select all of the indications in the indications store 117 for pre-processing as a batch. In a further embodiment, the policy engine is arranged to periodically access the indications store 117 to select a batch of indications for pre-processing. The policy engine may enter an idle or sleep mode between successive accesses to the indications store 117.

In another embodiment, the time stamp is omitted from indications and instead the sequence numbering of indications is used by the policy engine to identify a time sequence for the indications. In a further embodiment, the sequencing data from each indication is omitted and the time stamp alone used to identify the time sequence of the indications in the indication store 117.

In another embodiment, the policy engine is arranged to only pre-process duplicated indications. In a further embodiment, the policy engine is arranged only to pre-process contradictory indications. In another embodiment, the pre-processing is carried out by a separate system from the policy engine and which works independently of the policy engine on the indications in the indications store 117.

In a further embodiment, the indication store is omitted and the indication data is communicated between the UI, the performance monitoring system and the policy engine via message queues or socket communication.

It will be understood by those skilled in the art that while the embodiments described above refer to a computer system management application program, the invention may also be applied to other systems where a decision making component, such as a policy engine, is used to processes streams of data elements such as indications. Such applications may include general purpose decision making components in management application programs.

It will be understood by those skilled in the art that the apparatus that embodies a part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated by any suitable transmission or storage means so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method for processing data in a system management application program, said method comprising the steps of:
a) accessing a set of data elements collected for a system being managed by said system management application program, each data element comprising a message defining a change in said system and a time stamp;
b) identifying one or more groups of data elements in said set which correspond to contradictory or duplicated messages for said system management application program;
c) converting said data element messages into commands for sequential processing in accordance with said time stamps by said computer system management application program; and
d) for any groups of data elements that are identified as contradictory or duplicated, converting only the most recent data element, according to said time stamps, for processing in said sequential processing.

2. A method according to claim 1 in which if a group of data elements are identified as duplicated and if said commands determined by said group of data elements can be carried out collectively then converting said whole group of data elements into commands for processing in said sequential processing.

3. A method according to claim 1 in which if a group of data elements are identified as duplicated and said commands determined by said group of data elements can not be carried out collectively then converting only the most recent data element, according to said time stamps, for processing in said sequential processing.

4. A method according to claim 2 in which a set of rules define which commands can be carried out collectively.

5. A method according to claim 1 in which a set of rules is used to identify data element messages which are contradictory or duplicated.

6. A method according to claim 1 in which said data elements identify a device and a data set in said computer system to which said commands are directed.

7. A method according to claim 1 in which a subset of said set of data elements is selected for processing, said selection being based on said time stamps.

8. A method according to claim 7 in which said subset selection is carried out at predetermined time intervals.

9. A method according to claim 1 carried out by a decision making component associated with said system management application program, said component being arranged to convert said data elements into commands for said system in accordance with a set of management rules.

10. A method according to claim 1 in which step c) is carried out by a policy engine and step d) is carried out by a data element pre-processor.

11. A method according to claim 1 in which instead of said time stamp, each data element is assigned a unique sequence number used to determine the time order of said data element relative to other said data elements.

12. A method for processing data in a system management application program, said method comprising the steps of:
a) retrieving a set of data elements collected for a system being managed by said system management application program, each data element comprising a message defining a change in said system and a time stamp;
b) identifying one or more groups of data elements in said set which correspond to contradictory or duplicated messages for said system management application program;
c) for any groups of data elements identified as contradictory or duplicated, processing said set by removing all except the most recent identified data element from said set according to said time stamps; and
d) storing said processed set for use by a decision making component of said system management application program.

13. Apparatus for processing data in a system management application program, said apparatus being operable to:
access a set of data elements collected for a system being managed by said system management application program, each data element comprising a message defining a change in said system and a time stamp;
identify one or more groups of data elements in said set which correspond to contradictory or duplicated messages for said system management application program;
convert said data element messages into commands for sequential processing in accordance with said time stamps by said computer system management application program; and
for any groups of data elements that are identified as contradictory or duplicated, convert only the most recent data element, according to said time stamps, for processing in said sequential processing.

14. Apparatus according to claim 13 in which if a group of data elements are identified as duplicated and if said commands determined by said group of data elements can be carried out collectively then said apparatus is operable to convert said whole group of data elements into commands for processing in said sequential processing.

15. Apparatus according to claim 13 in which if a group of data elements are identified as duplicated and said commands determined by said group of data elements can not be carried out collectively then said apparatus is operable to convert only the most recent data element, according to said time stamps, for processing in said sequential processing.

16. Apparatus according to claim 14 in which a set of rules define which commands can be carried out collectively.

17. Apparatus according to claim 13 in which a set of rules is used to identify data element messages which are contradictory or duplicated.

18. Apparatus according to claim 13 in which said data elements identify a device and a data set in said computer system to which said commands are directed.

19. Apparatus according to claim 13 in which a subset of said set of data elements is selected for processing, said selection being based on said time stamps.

20. Apparatus according to claim 19 in which said subset selection is carried out at predetermined time intervals.

21. Apparatus according to claim 20 in which said apparatus is provided by a decision making component associated with said system management application program, said component being arranged to convert said data elements into commands for said system in accordance with a set of management rules.

22. Apparatus according to claim 13 in which instead of said time stamp, each data element is assigned a unique sequence number used to determine the time order of said data element relative to other said data elements.

23. Apparatus for processing data in a system management application program, said apparatus being operable to:
retrieve a set of data elements collected for a system being managed by said system management application program, each data element comprising a message defining a change in said system and a time stamp;
identify one or more groups of data elements in said set which correspond to contradictory or duplicated messages for said system management application program;
for any groups of data elements identified as contradictory or duplicated, process said set by removing all except the most recent identified data element from said set according to said time stamps; and
store said processed set for use by a decision making component of said system management application program.

24. Apparatus for processing data in a system management application program, said apparatus comprising:
means for retrieving a set of data elements collected for a system being managed by said system management application program, each data element comprising a message defining a change in said system and a time stamp;
means for identifying one or more groups of data elements in said set which correspond to contradictory or duplicated messages for said system management application program;
means for processing said set by removing all except the most recent identified data element from said set according to said time stamps, for any groups of data elements identified as contradictory or duplicated; and
means for storing said processed set for use by a decision making component of said system management application program.

25. A program or group of programs arranged to enable a programmable device or group of programmable devices to carry out the method of claim 1.

26. A program or group of programs arranged to enable a programmable device or group of programmable devices to carry out the method of claim 12.

27. A program or group of programs arranged to enable a programmable device or group of programmable devices to provide the apparatus of claim 13.

28. A program or group of programs arranged to enable a programmable device or group of programmable devices to provide the apparatus of claim 23.

29. A program or group of programs arranged to enable a programmable device or group of programmable devices to provide the apparatus of claim 24.
